(19) United States
(12) Patent Application Publication
(10) Pub. No.: US 2026/0346906 A1
(43) Pub. Date: Nov. 5, 2026

(54) Motorized Truck and Steering Control Method

(71) Applicants: NOBLELIFT INTELLIGENT EQUIPMENT CO.,LTD., Changxing (CN); Changxing Yongxuan Mechanical Co., Ltd, Changxing (CN)

(72) Inventors: Chao LIANG, Changxing County (CN); Jianhua ZHANG, Changxing County (CN); Zhiyu ZHANG, Changxing County (CN); Man LUO, Changxing County (CN); Jianwei WANG, Changxing County (CN); Jiale CAO, Changxing County (CN); Qiangqiang HUANG, Changxing County (CN); Linqiang SHI, Changxing County (CN); Yumei CHEN, Changxing County (CN)

(21) Appl. No.: 19/359,673

(22) Filed: Oct. 15, 2025

(30) Foreign Application Priority Data
Mar. 14, 2025 (CN) 202510302926.4

(51) Int. Cl. B62D 5/04; B62B 3/00; B62B 5/06; B62D 1/12

(52) U.S. Cl. CPC B62D 5/046; B62B 3/001; B62B 5/06; B62D 1/12; B62D 5/0403; B62D 5/0421

(57) ABSTRACT

A motorized truck and a steering control method. The motorized truck includes a frame and a steering wheel component for controlling a traveling direction of the frame, wherein the motorized truck comprises a driving assembly and a control handle, the driving assembly is installed on the frame for driving the steering wheel component to travel, and the control handle is installed on the frame for controlling the steering wheel component to steer; a support plate for mounting the driving assembly is installed at a bottom of the frame, and a steering component for receiving a steering signal of the control handle is disposed on the support plate; and an adjusting gear synchronously rotating with the steering wheel component is installed on a top of the steering wheel component, and the steering component is provided with a steering gear for driving the adjusting gear to rotate.

### CROSS-REFERENCE TO RELATED APPLICATION

The present disclosure claims priority to Chinese Patent Application No. 202510302926.4, filed on Mar. 14, 2025 and entitled “Motorized Truck and Steering Control Method”, the content of which is hereby incorporated by reference in its entirety.

### TECHNICAL FIELD

The present disclosure relates to the technical field of motorized trucks, and particularly relates to a motorized truck and a steering control method.

### BACKGROUND

A motorized truck is an industrial transport vehicle, which refers to various wheeled transport vehicles for performing loading, unloading, stacking and short-distance transportation operations on pallet cargoes in units, and is widely applied to ports, stations, airports, freight yards, factory workshops, warehouses, circulation centers, distribution centers, and the like, and is entered cabins, carriages and containers to load, unload and carry the pallet cargoes, therefore the motorized truck is an essential equipment for pallet transportation and container transportation.

The motorized truck carries a cargo by rotating wheel(s) and controls the transportation direction of the cargo by steering the wheel(s).

The Chinese Publication No. CN107840277A discloses a motorized truck having a control handle, such as a pallet truck or forklift, which is provided with a steering wheel controlled by the control handle, wherein the steering wheel is steered by a motor having an associated steering motor controller. In a normal operation mode, when the control handle is rotated relative to a chassis to steer the truck, the steering motor controller detects movement of the control handle and outputs a control signal to cause a steering motor to steer the wheel(s), so that the wheel(s) follow a control handle angle with a fixed predetermined offset (which is zero or non-zero). In a re-alignment operation mode, the controller is changing a predetermined angle offset, and the controller is aligning the wheel(s) with the control handle or the axis of the chassis.

The motorized truck disclosed above locks the steering angle of a wheel by decoupling the control handle from the wheel, so that the motorized truck advances and retracts at the angle via the locked steering angle, but when the motorized truck is just started, the locked rear wheel is prone to causing the motorized truck to advance in the locked direction, there is a certain potential safety hazard, and meanwhile, when the motorized truck is aligned with the advancing direction, it is difficult to reset the rear wheel of the motorized truck, thereby affecting the traveling direction of the motorized truck.

### SUMMARY

The present disclosure aims to overcome the defects in the art known to inventors, and provides a motorized truck, which is safe, reliable and simple to operate and has a driving wheel capable of resetting, and a steering control method.

To achieve the above disclosure purposes, the present disclosure uses the following technical solutions: a motorized truck, including a frame and a steering wheel component for controlling a traveling direction of the frame, wherein the motorized truck includes a driving assembly and a control handle, the driving assembly is installed on the frame for driving the wheel component to travel, and the control handle is installed on the frame for controlling the steering wheel component to steer; a support plate for mounting the driving assembly is installed at a bottom of the frame, and a steering component for receiving a steering signal of the control handle is disposed on the support plate; an adjusting gear, synchronously rotating with the steering wheel component (gearbox), is installed on a top of the steering wheel component (gearbox), and the steering component is provided with a steering gear for driving the adjusting gear to rotate; a sensing strip disposed in a circumferential direction of the adjusting gear is installed in the adjusting gear, a proximity switch for identifying the sensing strip is installed on the support plate, and an end portion of the sensing strip corresponds to a reset state of the steering wheel component; and the motorized truck includes an electronic control component and a reset button, and the electronic control component is installed on the frame for monitoring an identification signal of the proximity switch, and the reset button is installed on the frame for controlling the steering component to adjust a steering angle of the steering wheel component.

In some embodiments, as a solution of the present disclosure, the steering component includes a steering motor for driving the steering gear to rotate, the steering wheel component includes a steering wheel, and when the proximity switch identifies the end portion of the sensing strip, at this time, a steering direction of the steering wheel is aligned with the center plane of the frame.

In some embodiments, as a solution of the present disclosure, when the proximity switch identifies the end portion of the sensing strip, an identification signal of the proximity switch changes.

In some embodiments, as a solution of the present disclosure, the driving assembly is installed on an upper of the support plate, and the steering wheel component is installed lower of the support plate, and the driving assembly passes through the support plate to be connected with the steering wheel component.

In some embodiments, as a solution of the present disclosure, the steering wheel component includes a steering bracket and the steering wheel, which rotate synchronously, a connecting shaft for supporting the steering wheel is installed on the steering bracket, the adjusting gear is installed on the top of the steering bracket, and the adjusting gear and the steering bracket rotate synchronously.

In some embodiments, as a solution of the present disclosure, a driving shaft for rotating the steering wheel is disposed at the bottom of the driving assembly, the driving shaft passes through the center of a reference circle of the adjusting gear, the driving shaft is sleeved with a driving gear synchronously rotating with the driving shaft, and a transmission kit for transmitting the rotation of the driving gear to the steering wheel is disposed in the steering bracket.

In some embodiments, as a solution of the present disclosure, a fastening bolt for fixedly disposing the adjusting gear on the top of the steering bracket is disposed on the adjusting gear, and a sinking groove for mounting the sensing strip is formed in an upper surface of the adjusting gear.

A steering control method of a motorized truck, based on the motorized truck, including the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip;
step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies the position of the sensing strip in real time until an identification signal of a proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

In some embodiments, as a solution of the present disclosure, in step C, after the motorized truck is started, the reset button is not triggered and the control handle is pressed down, a steering potentiometer identifies a steering angle of the control handle, and sends a signal to the steering component to control a rotation of the steering component, so that a rotation angle of the steering wheel corresponds to the rotation angle of the control handle.

In some embodiments, as a solution of the present disclosure, in step C, after the motorized truck is started and it is not function to press down the reset button during the operation of the motorized truck, after the motorized truck stops, the reset button is pressed down, and the control handle is pressed down to reset the steering direction of the steering wheel.

Compared with the art known to inventors, the present disclosure has the beneficial effects as follows: the adjusting gear synchronously rotating with the steering wheel component is disposed on the steering wheel component, the proximity switch and the sensing strip located on the adjusting gear are disposed, a reset angle of the adjusting gear is identified by identifying the end portion of the sensing strip, and meanwhile, under the action of a reset component, the rotation of the adjusting gear is realized, and a reset operation on the steering wheel component is realized; and
by implementing steering reset of the steering wheel, the situation is avoided in which a vehicle does not move according to a required moving direction due to the self-locking of wheel(s) before the vehicle is started, so that the safe use of the vehicle is ensured.

### BRIEF DESCRIPTION OF THE DRAWINGS

FIG. 1 is a schematic structural diagram of the motorized truck of the present disclosure;

FIG. 2 is a schematic diagram of installation of a driving assembly and a steering wheel component;

FIG. 3 is a schematic structural diagram of the driving assembly and the steering wheel component;

FIG. 4 is a schematic structural diagram of a reset component and the steering wheel component;

FIG. 5 is a schematic diagram of use of the reset component;

FIG. 6 is a schematic structural diagram of an adjusting gear;

FIG. 7 is a flowchart of a use state of the steering control method of a motorized truck of the present application;

FIG. 8 is a control flowchart of the steering wheel component;

Reference signs: 1, frame; 2, driving assembly, 21, driving gear, 3, control handle, 31, reset button, 32, handle bracket, 33, interlock switch, 34, steering potentiometer, 4, support plate, 5, steering wheel component, 51, steering wheel, 52, steering bracket, 53, adjusting gear, 54, sensing strip, 55, transmission kit, 56, sinking groove, 6, steering component, 61, steering gear, 62, steering motor, 63, steering encoder, 7, electronic control component, 8, proximity switch.

### DETAILED DESCRIPTION OF THE EMBODIMENTS

The embodiments of the present disclosure are described in detail below in combination with the drawings.

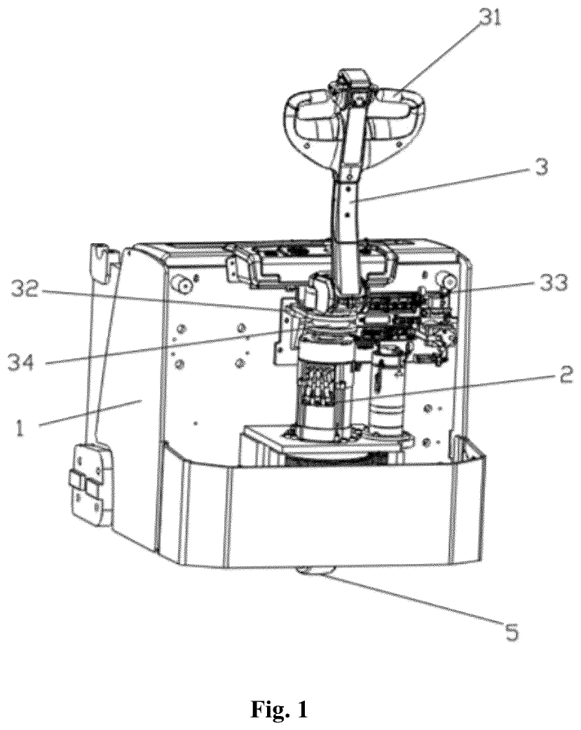

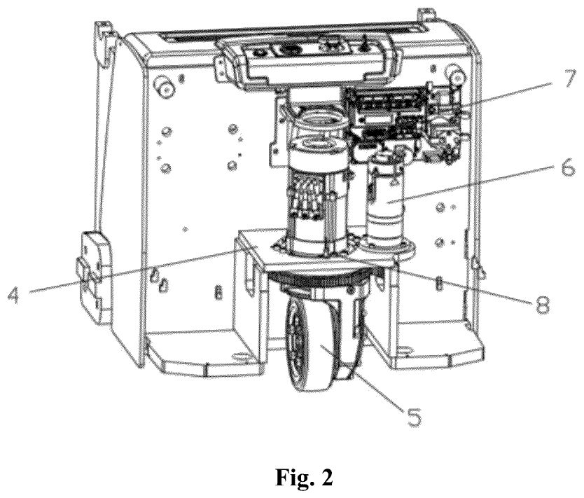

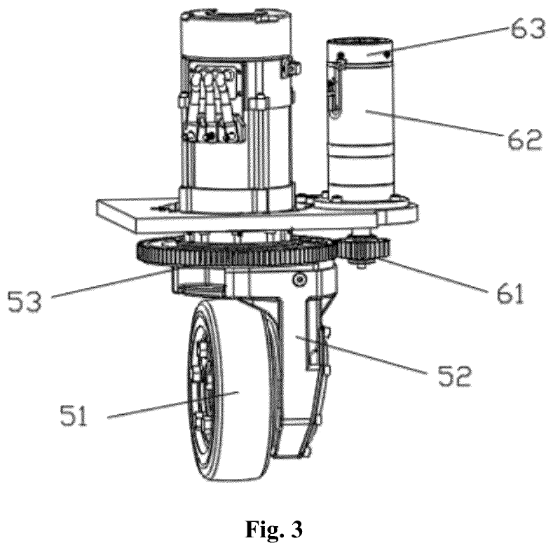

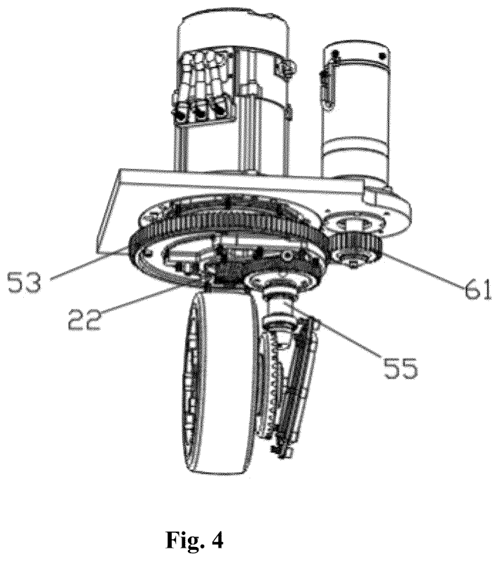

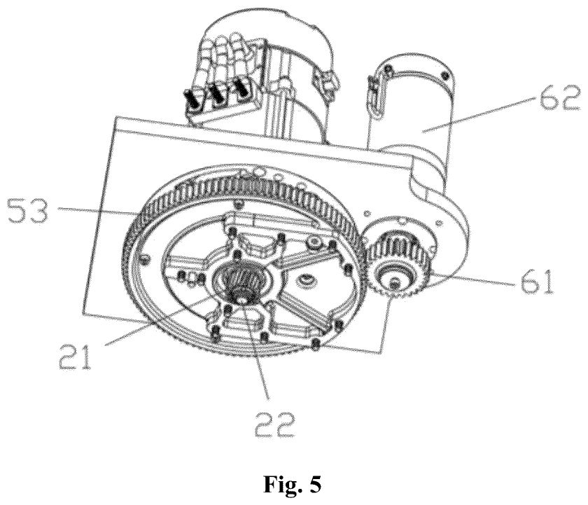

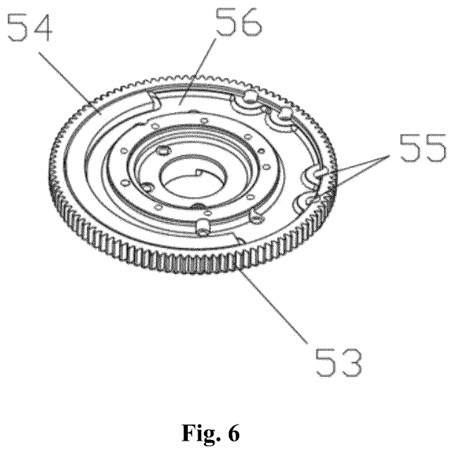

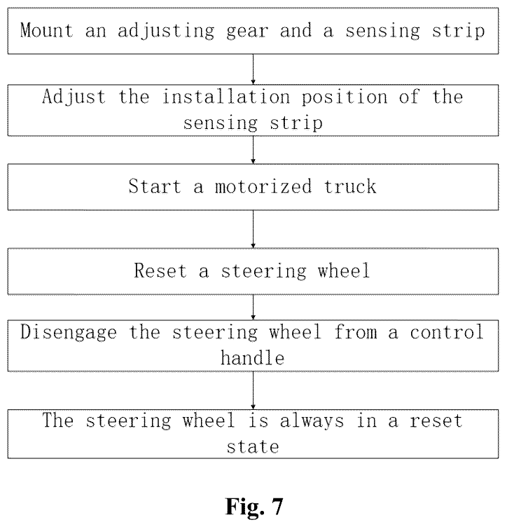

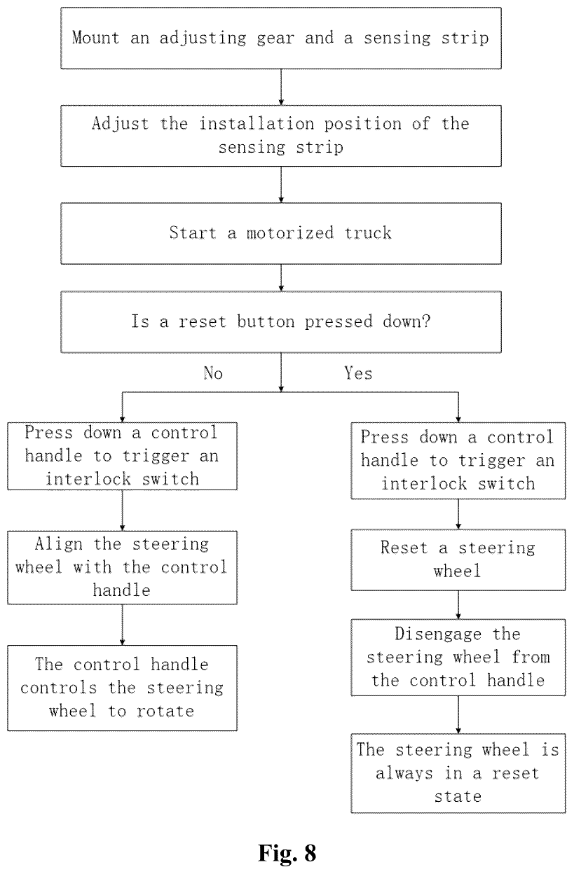

As shown in FIG. 1 to FIG. 8, a motorized truck, including a frame 1 and a steering wheel component 5 for controlling a traveling direction of the frame 1, wherein the motorized truck includes a driving assembly and a control handle, the driving assembly 2 is installed on the frame for driving the steering wheel component 5 to travel, and the control handle 3 is installed on the frame for controlling the steering wheel component 5 to steer; a support plate 4 for mounting the driving assembly 2 is installed at a bottom of the frame 1, and a steering component 6 for receiving a steering signal of the control handle 3 is disposed on the support plate 4; an adjusting gear 53 synchronously rotating with the steering wheel component 5 is installed on a top of the steering wheel component 5, and the steering component 6 is provided with a steering gear 61 for driving the adjusting gear 53 to rotate; a sensing strip 54 disposed in a circumferential direction of the adjusting gear 53 is installed in the adjusting gear 53, a proximity switch 8 for identifying the sensing strip 54 is installed on the support plate 4, and an end portion of the sensing strip 8 corresponds to a reset state of the steering wheel component 5; and the motorized truck includes an electronic control component and a reset button, and the electronic control component 7 is installed on the frame for identifying an identification signal of the proximity switch 8, and the reset button 31 is installed on the frame 1 for controlling the steering component 6 to adjust a steering angle of the steering wheel component.

The support plate 4 is located between the driving assembly 2 and the steering wheel component 5, the driving assembly 2 and the steering wheel component 5 are installed under a support effect of the support plate 4, and the steering component 6 is used for resetting a steering angle of the steering wheel component 5.

When the proximity switch 8 identifies the end portion of the sensing strip 54, the identification signal of the proximity switch 8 changes, the end portion of the sensing strip 54 corresponds to a reset angle of the steering wheel component 5, when the proximity switch 8 identifies the end portion of the sensing strip 54, at this time, the proximity switch 8 identifies the switching of a signal between the sensing strip 54 and the adjusting gear 53, so as to identify the position of the sensing strip 54 via the proximity switch 8, thereby judging whether the steering wheel component 5 is at the reset angle, and resetting the steering angle of the steering wheel component 5 according to the signal identification of the proximity switch 8.

The reset button 31 is used for controlling the steering component 6, and the electronic control component 7 is used for receiving the identification signal of the proximity switch 8 and immediately stopping the steering component 6.

The control handle 3, the driving assembly 2 and the steering wheel component 5 are coaxially disposed, a steering encoder 63 for identifying a rotation angle of the control handle 3 is installed on the control handle 3, and the steering component 6 is receiving an electrical signal of the steering encoder 63 to identify the rotation angle of the control handle 3, so as to control the steering wheel component 5 to rotate to a corresponding angle.

A handle bracket 32 for supporting the control handle 3 is installed on the frame 1, the handle bracket 32 is fixedly installed on the frame 1 by bolts, and the handle bracket 32 is used for supporting the rotation of the control handle 3.

The steering wheel component 5 includes a steering bracket 52 and a steering wheel 51, which rotate synchronously, a connecting shaft 54 for supporting the steering wheel 51 is installed on the steering bracket 52, the adjusting gear 53 is installed on the top of the steering bracket 52, and the adjusting gear 53 and the steering bracket 52 rotate synchronously.

The steering bracket 52 is used for vertically mounting the steering wheel 51, and the synchronous rotation of the steering bracket 52 and the steering wheel 51 is driven by the effect of the rotation of the adjusting gear 53 along the center of the adjusting gear 53, so as to adjust the steering angle of the steering wheel 51.

A driving shaft 22 for rotating the steering wheel 51 is disposed at a bottom of the driving assembly 2, the driving shaft 22 passes through a center of a reference circle of the adjusting gear 52, the driving shaft 22 is sleeved with a driving gear 21 synchronously rotating with the driving shaft 22, and a transmission kit 55 for transmitting a rotation of the driving gear 21 to the steering wheel 51 is disposed in the steering bracket 52.

The driving shaft 22 is sleeved with a bearing for supporting the rotation of the adjusting gear 53 to ensure that the adjusting gear 53 always rotates along the center, the driving gear 21 passes through the adjusting gear 53 under the action of the driving shaft 22, so that rotation of the driving gear 21 and the rotation of the adjusting gear 53 do not interfere with each other, and the transmission kit 55 is used for transmitting the rotation of the driving gear 21 to the steering wheel 51, so as to realize the rotation of the steering wheel 51.

A motor for driving the driving gear 21 to rotate is disposed in the driving assembly 2, so as to drive the steering wheel 51 to rotate.

A fastening bolt for fixedly disposing the adjusting gear 53 on the top of the steering bracket 52 is disposed on the adjusting gear 53, and a sinking groove 56 for mounting the sensing strip 54 is formed in an upper surface of the adjusting gear 53.

The number of the fastening bolts is set according to actual needs, the fastening bolt is used for fixedly disposing the adjusting gear 53 on the top of the steering bracket 52 to ensure the synchronous rotation of the adjusting gear 53 and the steering bracket 52, and the sinking groove 56 is used for mounting the sensing strip 54 to ensure the embedded installation of the sensing strip 54 on the adjusting gear 53.

The steering component 6 includes a steering motor 62 for driving the steering gear 61 to rotate, the steering wheel component includes a steering wheel, and when the proximity switch 8 identifies the end portion of the sensing strip 54, at this time, a steering direction of a steering wheel 51 is right ahead the frame 1.

Meanwhile, the steering gear 61 is always meshed with the adjusting gear 53, and the self-locking of the steering gear 61 is realized under a self-locking effect of the steering motor 62, thereby realizing the self-locking of the steering wheel 51.

A steering control method of a motorized truck, based on the motorized truck, including the following steps:
Step A: configuration: steering wheel component 5, mounted on the frame, with adjusting gear 53 and a sensing strip 54, rotating synchronously, in combination with a mounting plate where the control handle 3 is installed with an interlock switch 33, which is triggered by pressing down a control handle 3;
step B: adjusting an installation position of the sensing strip 54 by a proximity switch 8, to ensure that a steering wheel 51 is in a reset state when the proximity switch 8 identifies the end portion of the sensing strip 54, and to ensure the stability of the sensing strip 54 during the synchronous rotation of the adjusting gear 53 under the effect that the sensing strip 54 is embedded into the adjusting gear 53;
step C: starting the motorized truck, pressing down a reset button 31, and pressing down the control handle 3, so that the interlock switch 33 of the control handle 3 triggers the operation of the steering component 6, specifically, the interlock switch 33 of the control handle 3 transmits a trigger signal to the electronic control component 7, and the electronic control component 7 controls the operation of the steering component 6;
step D: the steering motor 62 of the steering component 6 drives the steering gear 61 to rotate, so that the rotation of the steering gear 61 drives the rotation of the meshed adjusting gear 53 and drives the jointly rotation of the adjusting gear 53 and the steering wheel component 5, the adjusting gear 53 drives the sensing strip 54 to rotate synchronously during rotating, the proximity switch 8 identifies the position of the sensing strip 54 in real time until the identification signal of the proximity switch 8 changes, at this time, the proximity switch 8 identifies the end portion of the sensing strip 8, the steering component 6 stops and self-locks the steering wheel 51, and the steering wheel 51 is in the reset state; and
step E: the steering component 6 disengages from a steering signal of the control handle 3, and the steering wheel 51 is always in the reset state.

In step C, after the motorized truck is started, the reset button 31 is not triggered and the control handle 3 is pressed down, a steering potentiometer 34 identifies a steering angle of the control handle 3, and sends a signal to the steering component 6 to control the rotation of the steering component 6.

The steering wheel 51 adjusts the steering angle of the steering wheel 51 according to the angle of the control handle 3, the steering angle of the steering wheel 51 corresponds to the angle of the control handle 3, the steering potentiometer 34 is installed on the control handle 3, the steering potentiometer 34 is in connection with the electronic control component 7, the electronic control component 7 sends a rotation angle signal corresponding to the steering encoder 63, so as to control the steering gear 61 to rotate a corresponding angle, the steering encoder 63 for receiving an electrical signal of the electronic control component 7 is installed on the steering component 6, so as to control the adjusting gear 53 to rotate by a corresponding angle, so that a rotation angle of the steering wheel 51 corresponds to a rotation angle of the control handle 3.

In step C, after the motorized truck is started and it is not function to press down the reset button 31 during the operation of the motorized truck, after the motorized truck stops, the reset button 31 is pressed down to reset the steering direction of the steering wheel 51.

After the motorized truck is started, and when the motorized truck is in an operation process, the operation of the motorized truck is stopped, even if the rotation angle of the control handle 3 is in a non-reset state, the reset button 31 is pressed down, the steering wheel 51 automatically finds the reset state (a zero-position switch) under the action of the steering component 6, the disengagement of a control shaft 31 and a steering shaft 21 is realized under the action of a controller 32, at this time, the steering shaft 21 is rotated independently, moreover, at this time, the self-locking of the steering of the steering wheel 51 is realized in a self-locking state of the steering component 6, and the steering wheel 51 is walked along a straight line in a reset direction of the motorized truck.

When the motorized truck is in an operation state, by means of the control of the electronic control component 7, the reset button 31 is not function at this time, and the reset button 31 is valid only after the steering wheel 51 is stopped, so as to ensure the safety.

The above description of the disclosed embodiments enables those skilled in the art to implement or use the present disclosure. Various modifications to these embodiments will be readily apparent to those skilled in the art, and the generic principles defined herein are implemented in other embodiments without departing from the spirit or scope of the present disclosure. Therefore, the present disclosure will not be limited to these embodiments illustrated herein, but is to be accorded the widest scope consistent with the principles and novel features disclosed herein.

Although the reference signs in the figures are used more herein: the frame 1, the driving assembly 2, the driving gear 21, the control handle 3, the reset button 31, the handle bracket 32, the interlock switch 33, the steering potentiometer 34, the support plate 4, the steering wheel component 5, the steering wheel 51, the steering bracket 52, the adjusting gear 53, the sensing strip 54, the transmission kit 55, the sinking groove 56, the steering component 6, the steering gear 61, the steering motor 62, the steering encoder 63, the electronic control component 7, the proximity switch 8 and other terms, the possibility of using other terms is not excluded. The use of these terms is only for a more convenience of describing and explaining the essence of the present disclosure; and interpretation thereof as any additional limitation is contrary to the spirit of the present disclosure.

1. A motorized truck, comprising a frame and a steering wheel component for controlling a traveling direction of the frame, wherein the motorized truck comprises a driving assembly and a control handle, the driving assembly is installed on the frame for driving the wheel component to travel, and the control handle is installed on the frame for controlling the steering wheel component to steer; a support plate for mounting the driving assembly is installed at a bottom of the frame, and a steering component for receiving a steering signal of the control handle is disposed on the support plate; an adjusting gear, synchronously rotating with the steering wheel component, is installed on a top of the steering wheel component, and the steering component is provided with a steering gear for driving the adjusting gear to rotate; a sensing strip disposed in a circumferential direction of the adjusting gear is installed in the adjusting gear, a proximity switch for identifying the sensing strip is installed on the support plate, and an end portion of the sensing strip corresponds to a reset state of the steering wheel component; and the motorized truck comprises an electronic control component and a reset button, and the electronic control component is installed on the frame for identifying an identification signal of the proximity switch, and the reset button is installed on the frame for controlling the steering component to adjust a steering angle of the steering wheel component.

2. The motorized truck as claimed in claim 1, wherein the steering component comprises a steering motor for driving the steering gear to rotate, the steering wheel component comprises a steering wheel, and when the proximity switch identifies the end portion of the sensing strip, at this time, a steering direction of the steering wheel is aligned with the center plane of the frame.

3. The motorized truck as claimed in claim 1, wherein when the proximity switch identifies the end portion of the sensing strip, an identification signal of the proximity switch changes.

4. The motorized truck as claimed in claim 1, wherein the driving assembly is installed on an upper of the support plate, and the steering wheel component is installed lower of the support plate, and the driving assembly passes through the support plate to be connected with the steering wheel component.

5. The motorized truck as claimed in claim 1, wherein the steering wheel component comprises a steering bracket and a steering wheel, which rotate synchronously, a connecting shaft for supporting the steering wheel is installed on the steering bracket, the adjusting gear is installed on a top of the steering bracket, and the adjusting gear and the steering bracket rotate synchronously.

6. The motorized truck as claimed in claim 5, wherein a driving shaft for rotating the steering wheel is disposed at a bottom of the driving assembly, the driving shaft passes through a center of a reference circle of the adjusting gear, the driving shaft is sleeved with a driving gear synchronously rotating with the driving shaft, and a transmission kit for transmitting a rotation of the driving gear to the steering wheel is disposed in the steering bracket.

7. The motorized truck as claimed in claim 5, wherein a fastening bolt for fixedly disposing the adjusting gear on the top of the steering bracket is disposed on the adjusting gear, and a sinking groove for mounting the sensing strip is formed in an upper surface of the adjusting gear.

8. A steering control method of a motorized truck, based on the motorized truck as claimed in claim 1, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip;
step C: starting the motorized truck, pressing down a reset button, and pressing down the control handle, so that the interlock switch of the control handle triggers an operation of the steering component;
step D: the steering component drives the adjusting gear and the steering wheel component to rotate synchronously, the adjusting gear drives the sensing strip to rotate jointly during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

9. The steering control method of the motorized truck as claimed in claim 8, wherein in step C, after the motorized truck is started, the reset button is not triggered and the control handle is pressed down, a steering potentiometer identifies a steering angle of the control handle, and sends a signal to the steering component to control a rotation of the steering component, so that a rotation angle of the steering wheel corresponds to a rotation angle of the control handle.

10. The steering control method of the motorized truck as claimed in claim 8, wherein in step C, after the motorized truck is started and it is not function to press down the reset button during the operation of the motorized truck, after the motorized truck stops, the reset button is pressed down, and the control handle is pressed down to reset a steering direction of the steering wheel(s).

11. A steering control method of a motorized truck, based on the motorized truck as claimed in claim 2, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip; step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

12. A steering control method of a motorized truck, based on the motorized truck as claimed in claim 3, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip; step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

13. A steering control method of a motorized truck, based on the motorized truck as claimed in claim 4, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip; step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

14. A steering control method of a motorized truck, based on the motorized truck as claimed in claim 5, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip; step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

15. A steering control method of a motorized truck, based on the motorized truck as claimed in claim 6, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip; step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.

16. A steering control method of a motorized truck, based on the motorized truck as claimed in claim 7, comprising the following steps:
Step A: configuration: steering wheel component, mounted on the frame, with adjusting gear and a sensing strip, rotating synchronously, in combination with a mounting plate where the control handle is installed with an interlock switch, which is triggered by pressing down a control handle;
step B: adjusting an installation position of the sensing strip by a proximity switch, to ensure that a steering wheel is in a reset state when the proximity switch identifies an end portion of the sensing strip; step C: starting the motorized truck, pressing down a reset button, and pressing down the control handle, so that the interlock switch of the control handle triggers an operation of the steering component;
step D: the steering component drives the adjusting gear and the steering wheel component to rotate jointly, the adjusting gear drives the sensing strip to rotate synchronously during rotating, the proximity switch identifies a position of the sensing strip in real time until an identification signal of the proximity switch changes, at this time, the proximity switch identifies the end portion of the sensing strip, the steering component stops and self-locks the steering wheel, and the steering wheel is in the reset state; and
step E: the steering component disengages from a steering signal of the control handle, and the steering wheel is always in the reset state.
